(19) United States
(12) Patent Application Publication
(10) Pub. No.: US 2003/0067891 A1
(43) Pub. Date: Apr. 10, 2003

(54) Integration of network control functions in a wireless network

(75) Inventors: Richard Alan Jones, Bristol (GB); Roger Nichol, Faringdon (GB)

Correspondence Address: FITCH EVEN TABIN AND FLANNERY, 120 SOUTH LA SALLE STREET, SUITE 1600, CHICAGO, IL, 60603-3406, US

(73) Assignee: IPWIRELESS, INC.

(21) Appl. No.: 10/173,183

(22) Filed: Jun. 17, 2002

(30) Foreign Application Priority Data
Jun. 18, 2001 (GB) 0114813.9

(51) Int. Cl. H04Q 7/00

(52) U.S. Cl. 370/328

(57) ABSTRACT

An integrated network control (INC) arrangement (300), for use in a UMTS wireless network, comprising an RNC element (250B) for management and control of base stations (250A); an SGSN element (270A) for session control and mobility management; and a GGSN element (270B) for external IP communication, the RNC, SGSN and GGSN elements being integrated together, and the GGSN means comprising only a Layer-2 Tunnelling Protocol Access Concentrator (LAC) element. This allows the arrangement to be optimised for Internet access and provides a number of advantages, resulting the ability for cost-effective network deployment to be achieved with multiple INC's, where each INC SGSN is responsible for only one INC RNC and each INC RNC controls a relatively small number of Node B's. This permits networks to be deployed incrementally without having to initially deploy infrastructure scaled to meet the requirements of a maximum sized network.

### FIELD OF THE INVENTION

This invention relates to wireless networks and particularly to the integration of functions in such networks. The invention finds particular application in IP (Internet Protocol) based wireless radio access networks.

### BACKGROUND OF THE INVENTION

In the field of this invention it is known that in a 3G (3rd Generation) or UMTS (Universal Mobile Telephone System) location of system functions such as UTRAN (Universal Terrestrial Radio Access Network) RNC (Radio Network Controller), UMTS SGSN (Serving GPRS Support Node) and UMTS GGSN (Gateway GPRS Support Node) is not critical for system operation. The current version of the proposed 3G standard (which may be found at the internet website www.3gpp.org) suggests that these functions may be distributed or co-located. Also, European patent publication EP1098539A2 (in the name of the present applicant) states that these functions may be distributed and co-located with a unique plurality of base stations (or Node B's)

However, the mere location of such functions does not offer any advantage or disadvantage (this being the reason that the proposed 3G standard mentioned above suggests that the functions may be distributed or co-located), and the RNC, SGSN and GGSN functions are typically provided discretely and separately, on separate respective software/hardware platforms. Further, the co-location possibility stated in EP1098539A2 mentioned above is restricted only to co-location with a plurality of base stations in order that total volume of data to be carried by backhaul transmission (transmission of data from a base station to/from a central office switch or core network equipment) is reduced.

A need therefore exists for integration of wireless network control functions whereby further advantages may be gained, particularly in the context of applications requiring only Internet access.

### STATEMENT OF INVENTION

In accordance with a first aspect of the present invention there is provided a network control arrangement for use in a UMTS wireless network, the arrangement comprising: RNC means for providing management and control of base stations within the network; SGSN means for providing session control and mobility management within the network; and GGSN means for providing external IP communication, wherein the RNC means, the SGSN means and the GGSN means are integrated together, and the GGSN means comprises substantially only Layer-2 Tunnelling Protocol Access Concentrator means, whereby internet access may be facilitated.

In accordance with a second aspect of the present invention there is provided a wireless network including a network control arrangement comprising: RNC means for providing management and control of base stations within the network; SGSN means for providing session control and mobility management within the network; and GGSN means for providing external IP communication, wherein the RNC means, the SGSN means and the GGSN means are integrated together, and the GGSN means comprises substantially only Layer-2 Tunnelling Protocol Access Concentrator means, whereby internet access may be facilitated.

### BRIEF DESCRIPTION OF THE DRAWINGS

One UMTS system optimised for Internet access and incorporating the present invention will now be described, by way of example only, with reference to the accompanying drawings, in which:

FIG. 1 shows a block-schematic diagram of a conventional UMTS wireless network known in the prior art;

FIG. 2 shows a block-schematic diagram of a UMTS wireless network, optimised for Internet access, in accordance with a preferred embodiment of the invention;

FIG. 3 shows a simplified block-schematic diagram of an integrated network controller used in the system of FIG. 2, and incorporating the present invention;

FIG. 4 shows a block-schematic diagram of the integrated network controller of FIG. 2 and FIG. 3, in the context of its adjacent network elements; and

FIG. 5 shows a schematic representation of a possible hardware implementation of the integrated network controller of FIG. 2, FIG. 3 and FIG. 4.

### DESCRIPTION OF PREFERRED EMBODIMENT

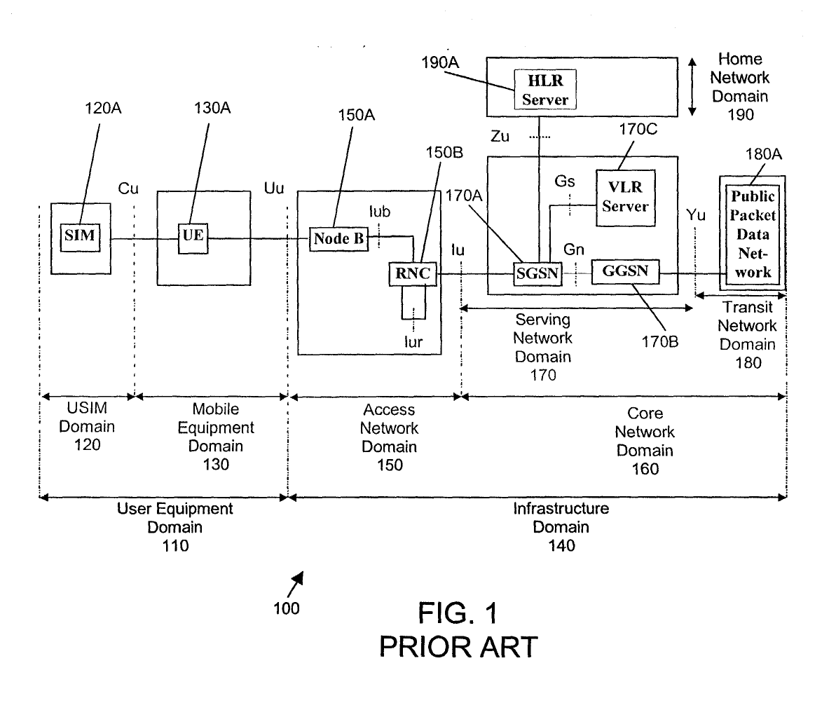

Referring firstly to FIG. 1, a typical, standard UMTS network (100) is conveniently considered as comprising: a user equipment domain (110), made up of a user SIM (USIM) domain (120) and a mobile equipment domain (130); and an infrastructure domain (140), made up of an access network domain (150), and a core network domain (160), which is in turn made up of a serving network domain (170) and a transit network domain (180) and a home network domain (190).

In the mobile equipment domain (130), user equipment UE (130A) receives data from a user SIM (120A) in the USIM domain 120 via the wired Cu interface. The UE (130A) communicates data with a Node B (150A) in the network access domain (150) via the wireless Uu interface. Within the network access domain(150), the Node B (150A) communicates with an RNC (150B) via the Iub interface. The RNC (150B) commmunicates with other RNC's (not shown) via the Iur interface. The RNC (150B) communicates with a SGSN (170A) in the serving network domain (170) via the Iu interface. Within the serving network domain (170), the SGSN (170A) communicates with a GGSN (170B) via the Gn interface, and the SGSN (170A) communicates with a VLR server (170C) via the Gs interface. The SGSN (170A) communicates with an HLR server (190A) in the home network domain (190) via the Zu interface. The GGSN (170B) communicates with public data network (180A) in the transit network domain (180) via the Yu interface.

Thus, the elements RNC (150B), SGSN (170A) and GGSN (170B) are conventionally provided as discrete and separate units (on their own respective software/hardware platforms) divided across the access network domain (150) and the serving network domain (170), as shown the FIG. 1.

The RNC (150B) is the UTRAN element responsible for the control and allocation of resources for numerous Node B's (150A); typically 50 to 100 Node B's may be controlled by one RNC. The RNC also provides reliable delivery of user traffic over the air interfaces. RNC's communicate with each other (via the interface Iur) to support handover and macrodiversity.

The SGSN (170A) is the UMTS Core Network element responsible for Session Control and interface to the Location Registers (HLR and VLR). The SGSN is a large centralised controller for many RNCs.

The GGSN (170B) is the UMTS Core Network element responsible for concentrating and tunnelling user data within the core packet network to the ultimate destination (e.g., internet service provider—ISP).

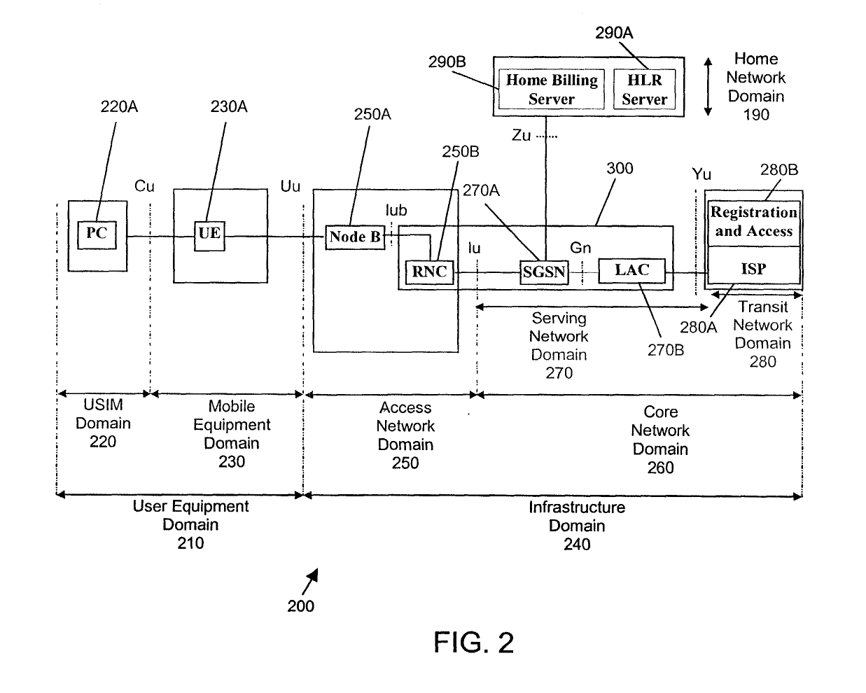

Referring now to FIG. 2, in a UMTS network (200) in accordance with a preferred embodiment of the present invention, an integrated network controller (300), hereafter referred to as INC, integrates the relevant functions of the RNC, SGSN and GGSN, optimising the network architecture for Internet access. It will be particularly noted that in the INC (300) a standard Layer-2 Tunnelling Protocol (L2TP) Access Concentrator (LAC-270B) replaces the GGSN functionality referred to in FIG. 1.

In the UMTS network (200), a personal computer PC (220A) communicates data, via user equipment UE (230A) and the UMTS network, with an ISP (280A). In order to initially register the user with the ISP to allow access, user data such as SIM data is transferred from the user's PC (220A) to an access and registration element (280B) at the ISP (Internet Service Provider). The network 200 generally operates similarly to the conventional network 100 described above in relation to FIG. 1, but is optimised for Internet access.

Thus, in mobile equipment domain (230), user equipment UE (230A) receives data from the personal computer (220A) in the USIM domain 120 via the wired Cu interface. The UE (230A) communicates data with a Node B (250A) in the network access domain (250) via the wireless Uu interface. Within the network access domain (250), the Node B (250A) communicates with an RNC (150B) via the Iub interface. The RNC (250B) communicates with a SGSN (170A) in the serving network domain (270) via the Iu interface. Within the serving network domain (170), and the SGSN (270A) communicates with a LAC (270B) via the Gn interface. The SGSN (270A) communicates with an HLR server (290A) and home billing server (290B) in the home network domain (290) via the Zu interface. The LAC (270B) communicates with public data network (180A) in the transit network domain (280) via the Yu interface.

Thus, the elements RNC (250B), SGSN (270A) and LAC (270B) are integrated together, and (as will be described in greater detail below) advantageously housed in a single housing.

The inventors have realised that several significant advantages can be gained from simplfying and integrating the Access Network Domain RNC and the Serving Network Domain SGSN and GGSN (reduced to LAC) functions, for optimised Internet access in this way, as follows:

In an access system that is used entirely for Internet access, all calls are user originated; the system therefore does not need to track the location of idle users. There is thus no need for paging, therefore SGSNs do not need to coordinate paging over multiple RNCs. The RNCs themselves do not need to control a large number of cells for similar reasons.

Full Mobility in terms of seamless handoff between cells is not required (assuming the user does not require mobile internet access), i.e., the Iu interface for the user never changes. This allows the complexity of the SGSN function to be considerably reduced, and removes the need to have it centrally located (serving a number of RNC's).

Circuit switched voice and data does not need to be directly supported, eliminating the need for complex circuit switched equipment. The unit cost of the RNC and SGSN can thus be considerably reduced.

The replacement of the GGSN by an integrated L2TP Access Concentrator allows for the use of standard Internet protocols on the network side of the INC. This reduces total network cost by facilitating use of standard IP network equipment rather than UMTS-specific or GPRS-specific network equipment.

These factors together mean that cost-effective network deployment can be achieved with multiple INC's, where each INC SGSN is responsible for only one INC RNC and each INC RNC controls a relatively small number (say, 6) of Node B's.

This permits networks to be deployed incrementally without having to initially deploy infrastructure scaled to meet the requirements of a maximum sized network.

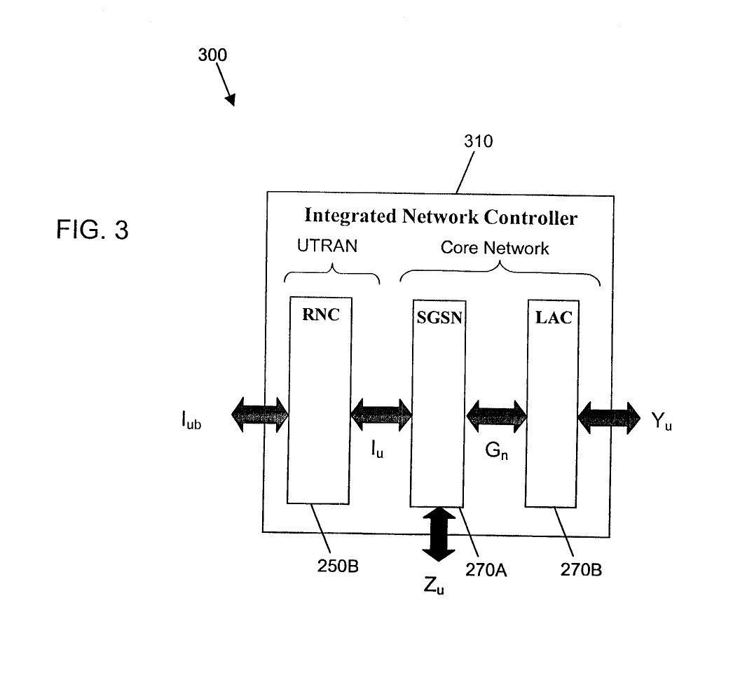

Referring now to FIG. 3, the INC 300 integrates the following, normally discrete, elements into a single housing 310 based on a single software/hardware platform (as will be described in greater detail below):

1. Radio Network Controller (RNC) (250B)

This functionality provides for the management and control of the Node B's (radio base stations) connected to it.

2. Serving GPRS Support Node (SGSN) (270A)

This functionality provides for session control and mobility management.

3. LAC (270B)

This functionality provides for the gateway to other IP Networks such as the Internet. An L2TP Access Concentrator is used to provide this functionality. The INC 300 is capable of managing a relatively small number of Node B's, e.g., 6 sector carriers. The INC tunnels user data to the Internet Service Provider using L2TP transported over IP.

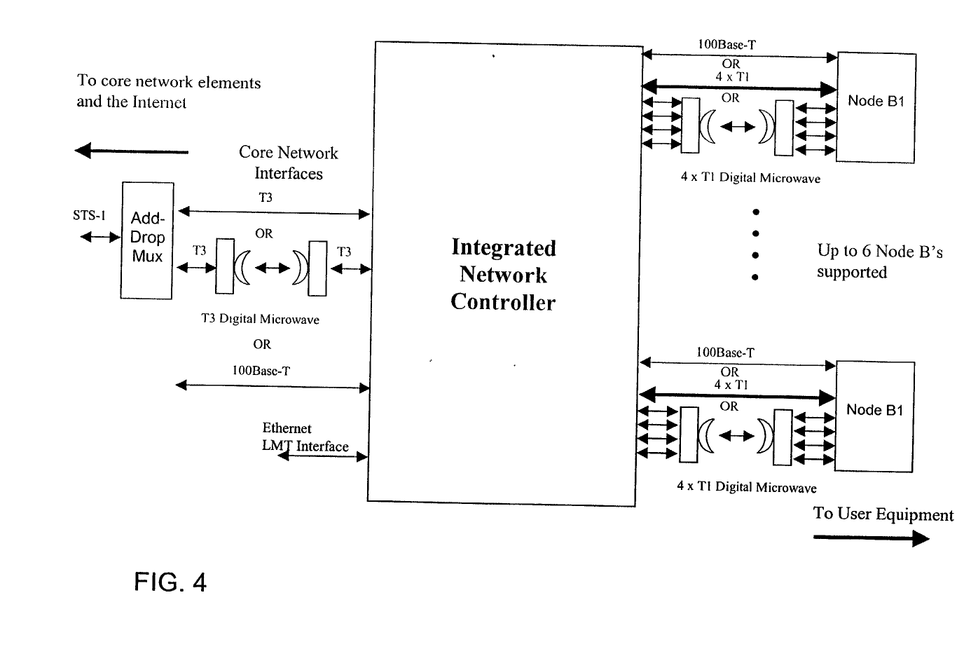

FIG. 4 shows the INC 300 in the context of its immediately adjacent system elements.

The INC controls up to six Node B's connected either locally via 100Base-T Ethernet or remotely via quad T1 point-to-point microwave link.

Data is concentrated and tunnelled to the ISP using L2TP over IP on a T3 link (via a concentrator, in the form of an ‘Add-Drop Muliplexer’, to interface a number of T3 data streams into a higher data rate STS-1 line) or 100Base-T Ethernet.

Traditionally, the RNC, SGSN and GGSN are implemented as separate entities on separate platforms. In the preferred embodiment of the present invention, these entities are intelligently and strategically arranged into a single platform to reduce cost and to limit the degree of scalability required.

The Integrated Network Controller incorporates the Radio Network Controller functions. The RNC communicates with up to 6 Node B's over the Iub interfaces and the SGSN over the internal logical Iu interface.

The Integrated Network Controller incorporates some of the SGSN functions. This element is responsible for Session Control.

An L2TP Access Concentrator (LAC) that is implemented within the Integrated Network Controller replaces the GGSN functions. The LAC tunnels user sessions to L2TP Network Servers located within target ISPs or as part of the Core Network.

As also shown in FIG. 3, the Integrated Network Controller (300) has 5 interfaces as shown, 3 external and 2 internal. Each interface is defined as follows.

Iub—The Iub covers the external interface between the Integrated Network Controller and a Node B. This interface uses either Ethernet or T1 based communication.

Iu—The Iu covers an internal Integrated Network Controller interface between a RNC and a SGSN.

Gn—The Gn covers an internal Integrated Network Controller interface between a SGSN and a LAC.

Zu—The Zu covers an external Integrated Network Controller interface between an SGSN and an HLR server.

Yu—The Yu covers the external interface between the Integrated Network Controller and the Core Network Functionality. This interface uses IP over either T3 or 100Base-T Ethernet.

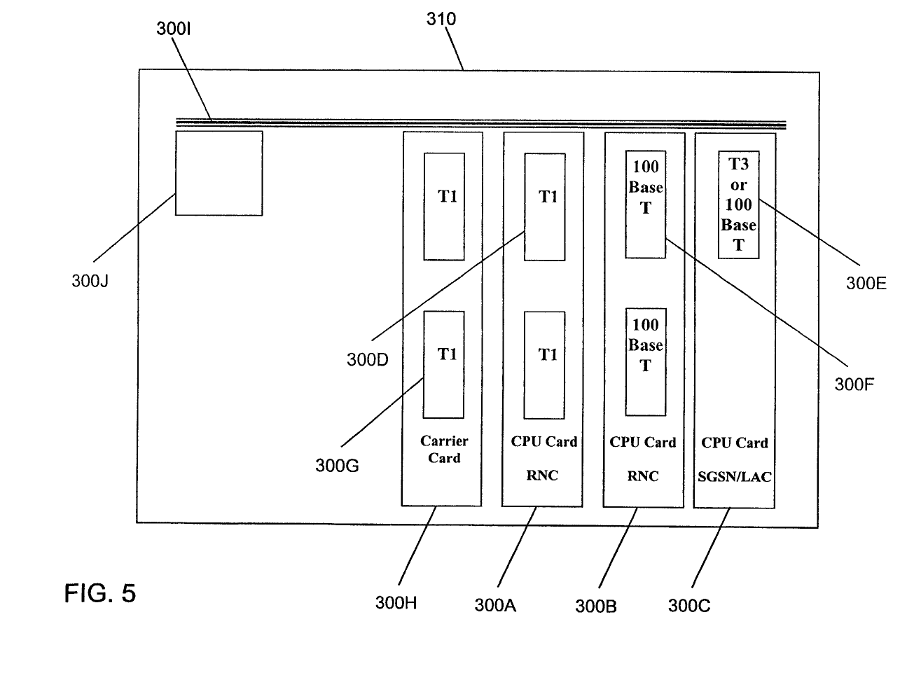

FIG. 5 illustrates a possible physical architecture for the INC. It is based around a Compact-PCI rack with CPU card(s) (300A, 300B and 300C) providing the intelligence and T3, T1 and Ethernet cards (300D, 300E and 300F) mounted on the CPU cards (or, such as T1 card 300G, mounted on a carrier cards such as 300H connected directly to the backplane) providing the interface capability, all CPU and carrier cards being mounted on a common compact-PCI backplane (300I). It will be understood that power is provided by a power unit (300J).

It will be understood that the software for operating the CPU cards (300A, 300B and 300C) to allow the arrangement to function may be uploaded to the CPU cards via a standard serial RS-232 LMT port, for initial installation, upgrade or maintenance purposes as necessary. It will be appreciated that the software may be provided as a computer program element carried on any suitable data carrier (not shown) such as a magnetic or optical computer disc. Alternatively, it will be understood that the software could be transmitted across the network and uploaded to the CPU cards (300A, 300B and 300C) in this way if desired.

It will be appreciated that integration of the RNC, SGSN and GGSN (reduced to LAC functionality alone) into the integrated network controller module (300) as described above allows all three functions to share a single software/hardware platform which can use low-cost standard interface technologies such as 100Base-T Ethernet and T1. It will be appreciated that the internal interfaces Iu and Gn can be provided simply and efficiently locally within the INC across the common PCI backplane.

In summary, it will be understood that the integration of network control functions in a wireless network described above, in contrast to the discrete and independent arrangement of prior art network elements, is optimised for Internet access, allowing a significant number of simplifications and advantages:

the SGSN's do not need to coordinate paging over multiple RNC's; the RNC's themselves do not need to control a large number of cells.

allows the complexity of the SGSN function to be considerably reduced, and removes the need to have it centrally located (serving a number of RNC's).

eliminates the need for complex circuit switched equipment, allowing the unit cost of the RNC and SGSN to be considerably reduced.

allows for the use of standard Internet protocols on the network side of the INC, reducing total network cost by facilitating use of standard IP network equipment rather than UMTS-specific or GPRS-specific network equipment.

These factors together mean that cost-effective network deployment can be achieved with multiple INC's, where each INC SGSN is responsible for only one INC RNC and each INC RNC controls a relatively small number (e.g., 6) of Node B's.

This permits networks to be deployed incrementally without having to initially deploy infrastructure scaled to meet the requirements of a maximum sized network.

1. A network control arrangement for use in a UMTS wireless network, the arrangement comprising:
RNC means for providing management and control of base stations within the network;
SGSN means for providing session control and mobility management within the network; and
GGSN means for providing external IP communication,
wherein
the RNC means, the SGSN means and the GGSN means are integrated together, and
the GGSN means comprises substantially only Layer-2 Tunnelling Protocol Access Concentrator means,
whereby internet access may be facilitated.

2. The network control arrangement as claimed in claim 1 wherein the arrangement comprises an Ethernet interface for communicating with a base station.

3. The network control arrangement as claimed in claim 2 wherein the Ethernet interface is a 100Base-T Ethernet interface.

4. The network control arrangement as claimed in claim 1 wherein the arrangement comprises a T1 interface for communicating with a base station.

5. The network control arrangement as claimed in claim 4 wherein the T1 interface comprises a quad T1 interface.

6. The network control arrangement as claimed in claim 1 wherein the arrangement comprises a T3 interface for providing external communication via IP over T3.

7. The network control arrangement as claimed in claim 1 wherein the arrangement comprises an Ethernet interface for providing external communication via IP over Ethernet.

8. The network control arrangement as claimed in claim 1 wherein the arrangement is implemented on a single platform.

9. The network control arrangement as claimed in claim 8 wherein the arrangement comprises:
at least one processor card for providing processing functionality for the RNC, SGSN and GGSN means;
at least one interface card for providing external interface functionality; and
interconnection means for connecting the at least one processor card and the at least one interface card.

10. The network control arrangement as claimed in claim 9 wherein the interconnection means comprises a card mounting means for mounting cards one on another.

11. The network control arrangement as claimed in claim 9 wherein the interconnection means comprises a compact-PCI backplane.

12. The network control arrangement as claimed in claim 1 wherein the RNC means is arranged to provide management and control of a plurality of base stations within the network.

13. The network control arrangement as claimed in claim 12 wherein the RNC means is arranged to provide management and control of six base stations within the network.

14. A wireless network including a network control arrangement comprising:
RNC means for providing management and control of base stations within the network;
SGSN means for providing session control and mobility management within the network; and
GGSN means for providing external IP communication,
wherein
the RNC means, the SGSN means and the GGSN means are integrated together, and
the GGSN means comprises substantially only Layer-2 Tunnelling Protocol Access Concentrator means,
whereby internet access may be facilitated.

15. The wireless network as claimed in claim 14 wherein the network control arrangement comprises at least one of:
an Ethernet interface for communicating with a base station;
a T1 interface for communicating with a base station;
a T3 interface for providing external communication via IP over T3; and
an Ethernet interface for providing external communication via IP over Ethernet.

16. The wireless network as claimed in claim 14 wherein the network control arrangement comprises:
at least one processor card for providing processing functionality for the RNC, SGSN and GGSN means;
at least one interface card for providing external interface functionality; and
interconnection means for connecting the at least one processor card and the at least one interface card.

17. The wireless network as claimed in claim 16 wherein the interconnection means comprises a card mounting means for mounting cards one on another.

18. The wireless network as claimed in claim 14 wherein the RNC means is arranged to provide management and control of a plurality of base stations within the network.

19. The wireless network as claimed in claim 14 wherein the wireless network is a UMTS network.

20. A computer program element comprising computer program means for performing RNC, SGSN and GGSN functions in a network control arrangement as claimed in claim 1.
